(19) United States
(12) Patent Application Publication
(10) Pub. No.: US 2012/0194818 A1
(43) Pub. Date: Aug. 2, 2012

(54) Gas Analyzer for Measuring the Mercury Content of a Gas

(75) Inventor: Rolf DISCH, Eichstetten (DE)

(73) Assignee: SICK MAIHAK GMBH, Waldkirch (DE)

(21) Appl. No.: 13/356,151

(22) Filed: Jan. 23, 2012

(30) Foreign Application Priority Data
Jan. 27, 2011 (EP) 11152377.5

(51) Int. Cl. G01N 21/61

(52) U.S. Cl. 356/437

(57) ABSTRACT

The invention relates to a gas analyzer for measuring the mercury content of a gas having an Hg light source which transmits transmitted light having wavelengths of at least one spectral line of the mercury, a measuring cell in which the gas to be measured is present, a light receiver, an evaluation unit and a test cuvette which can be introduced into the beam path for checking the operability. To provide an improved gas analyzer which can be calibrated in a simple manner as well as a corresponding improved calibration method, provision is made that the test cuvette contains benzol as a test gas.

The invention relates to a gas analyzer for measuring the mercury content of a gas having an Hg light source which transmits transmitted light having wavelengths of at least one spectral line of the mercury, a measuring cell including gas containing mercury, a light receiver, an evaluation unit and a test cuvette which can be introduced into the beam path for checking the operability, as well as to a method for calibrating the gas analyzer.

Generic apparatus for measuring the mercury concentration in a gas are known. These apparatus have a mercury lamp as a light source from which the spectral lines of monoisotopic mercury are transmitted along an optical axis. The light source is located in a magnetic field which is aligned in the direction of the optical axis so that the σ+, σ− polarized Zeeman components of the spectral line are produced (longitudinal Zeeman effect). The light thus generated is conducted through an absorption cell in which absorption at the gas containing Hg takes place. The one of the two components is displaced so far by the magnetic splitting that it cannot be absorbed by the natural Hg, whereas the other component also lies in the absorption in the displaced state. The absorption and thus the Hg content can be determined by a comparison of these two components after passing through the absorption cell. To be able to examine the absorption of the two components separately, they are separated in an optical separation apparatus.

The measuring capability of a gas measuring device in general or of such a mercury measuring device in particular has to be ensured by means of cyclic checking measurements.

It is therefore known for calibration to use measuring cuvettes which are flushed in a known concentration with the component to be measured, which can be realized in an extractive system with cycle times and a concentration which can be selected as desired (in particular in the range of the measurement range of the device).

Disadvantages of this flushing method are the in part long calibration/test times since the gas has to be charged via the extraction system. If the measuring component is mercury, the realization of a test cuvette with mercury is itself difficult - in particular with small concentrations to be measured. One possibility would be to set the vapor pressure over a drop of mercury very exactly. This is, however, very complex since in order, for example, to obtain a mercury signal which corresponds to a concentration of 10 μg/m³ in a 30 cm cuvette, the test cuvette would have to have a thickness of only 0.04 mm and would in addition have to be thermostatted very precisely to 45° C. If the concentration is to be set to 1% via the vapor pressure, a temperature precision of ≦0.15° C. would be necessary. Both are very difficult to realize, if at all.

Another known calibration possibility is to swivel a closed, gas-filled cuvette having a known mercury concentration into the measurement path. The temperature dependence is much smaller here since its influence is only present via the temperature expansion properties and pressure expansion properties, but no longer via a change in the mercury concentration. The signal to be achieved with the test cuvette should correspond to the signal over the measurement path. Such a calibration can be carried out in very short times. However, the concentration does not remain stable due to adsorption of the mercury at the quartz surface of the test cuvette.

A method is known from the article by Ganeyev et al.: “New Zeeman atomic absorption spectroscopy approach for mercury isotope analysis” from Spectrochimica Acta, Vol 47B, No. 11, pp 1325-1338, 1992, in which an isotope analysis is carried out with the aid of the direct Zeeman effect and the indirect Zeeman effect. In this respect, a calibration takes place with a sample containing ²⁰²Hg.

An apparatus and a method are described in the article by Koizumi et al.: “An application of the Zeeman effect to atomic absorption spectrometry: a new method for background correction” from Spectrochimica Acta, Vol 31B, No. 5, pp 237-255, 1976, in which atoms are examined with the aid of the Zeeman effect and in which a substrate can be taken into account which is formed by other molecules, e.g. benzol.

Starting from this prior art, it is the object of the invention to provide an improved gas analyzer for measuring the mercury content of a gas which can be calibrated in an easy manner and to provide a corresponding improved calibration method.

This object is satisfied by a gas analyzer having the features of claim 1 as well as by a method having the features of claim 7.

The gas analyzer in accordance with the invention for measuring the mercury content of a gas includes an Hg light source which transmits transmitted light with wavelengths of at least one spectral line of the mercury, a measuring cell in which the gas to be measured is present, a light receiver, an evaluation unit and a test cuvette which can be introduced into the beam path for testing the operability, with the test cuvette containing benzol as the test gas.

Benzol (C6H6) is a substance which absorbs in the relevant spectral range of the Hg in a wide absorption band, but does not occur in the gas matrix to be measured at the measuring point, or only occurs in concentrations which do not impair the measurement. The test cuvette is itself a standard quartz cuvette which is ablated after the filling and thus permanently sealed.

Benzol can be filled into the test cuvette in very large concentrations so that wall reactions of the benzol can be neglected. The concentration in the cuvette is stable over a long time; the measuring signal is much less sensitive to temperature than in a mercury cuvette.

Benzol can advantageously be purchased commercially as a test gas.

The level of the calibration signal can simply be set via the concentration of the benzol or the length of the test cuvette.

The solution in accordance with the invention is much less time consuming with respect to a flushing of the measuring cuvette via heated gas lines, which increases the availability of the measuring device.

The layer thickness of the test cuvette is typically 10 to 20 mm, the diameter 20 mm.

In a further development of the invention, the concentration of the benzol amounts to approximately 1%; the optical light path length in the test cuvette amounts to approximately 2 cm; and the pressure in the test cuvette amounts to approximately 100 mbar. If the temperature in the test cuvette then amounts to approximately room temperature, the test cuvette delivers a measurement signal of approximately 15 μg/m³. The level of this signal can be set in a simple manner via the concentration of the filling gas.

A plurality of mutually connected test cuvettes each having a different optical path length is advantageously provided. A linearity test can thereby also be carried out very fast. The measurement signals of the individual test cuvettes relative to one another have to behave like their corresponding optical path lengths independently of the concentration filled in.

In this respect, changing combinations of at least three test cuvettes having different path lengths are preferably provided. So that the same concentration is present in all test cuvettes and so that a meaningful linearity test can take place, the test cuvettes are mutually connected.

The calibration method itself includes the steps:
generating light having wavelengths of at least one Hg spectral line;
providing a test cuvette with benzol of a known concentration as a test gas and thus with known calibration values of the test cuvette at the wavelengths of the Hg spectral line;
inserting the test cuvette into the beam path; and
calibrating the gas analyzer to the known calibration values.

The calibration values can be determined as follows, for example: On the putting into operation of the gas analyzer, the gas analyzer is first calibrated for the first time by means of charging a known mercury concentration into the measuring cuvette. A measured absorption value for the test cuvette is then determined and stored as the calibration value and in all following calibrations with the test cuvette, the currently obtained measured value is compared with the calibration value and the gas analyzer is thus calibrated in operation.

In this respect, as already mentioned, different mutually connected test cuvettes each having different optical path lengths can be used.

The invention will be explained in detail in the following with reference to an embodiment and to the drawing. There are shown in the drawing:

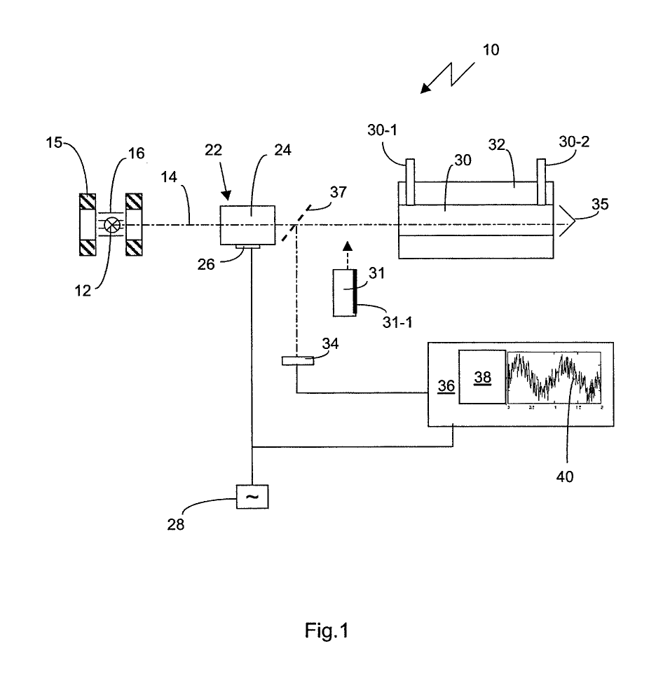

FIG. 1 a schematic representation of a gas analyzer for measuring the mercury content of a gas;

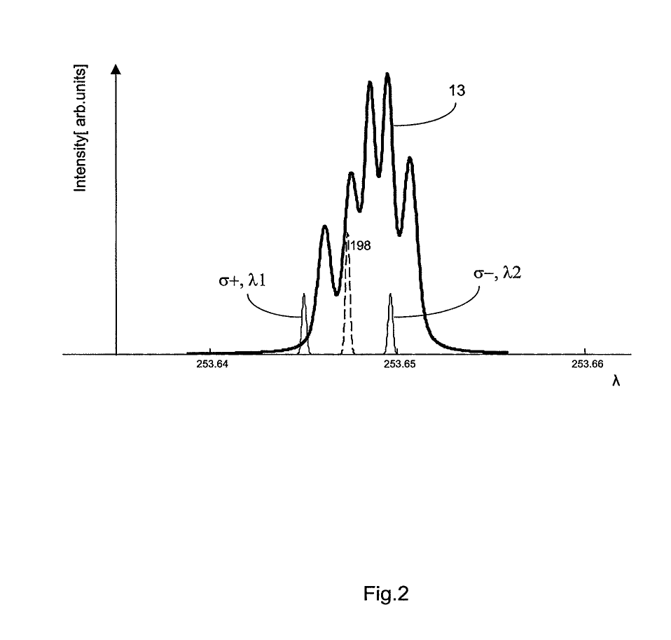

FIG. 2 a mercury spectrum of a light source of the gas analyzer and the absorption spectrum;

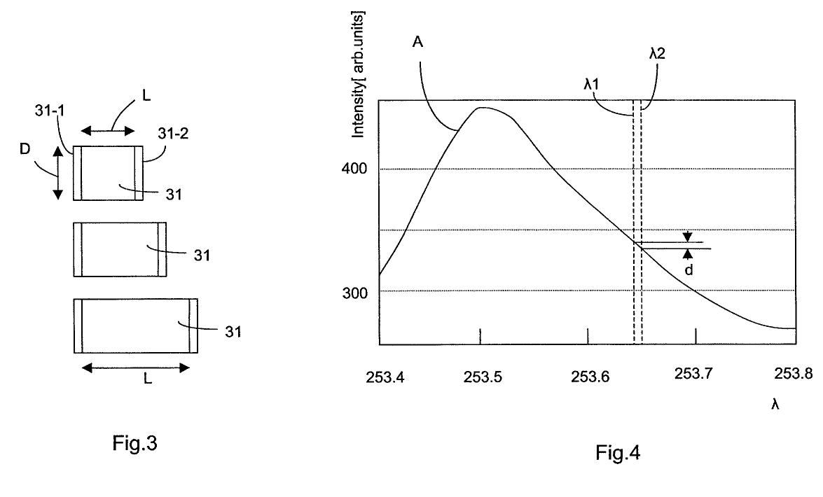

FIG. 3 a schematic representation of a set of test cuvettes; and

An apparatus 10 for measuring the mercury content in a gas such as is schematically shown in FIG. 1 has a light source 12, in particular an electrode-less gas discharge lamp, for transmitting mercury spectral lines along an optical axis 14.

The light source 12 contains monoisotopic ¹⁹⁸Hg and is located in a magnetic field 165 which is as homogenous as possible, which is generated by a magnet 15 and which is aligned parallel to the optical axis at the point of light generation. The σ+ and σ− polarized Zeeman components λ1 and λ2 respectively of the spectral line are thereby generated on the basis of the longitudinal Zeeman effect.

So that the splitting of the spectral lines is large enough and the spectral lines remain sharp, that is are displaced spectrally by the same amount at each point in the lamp, a sufficiently strong and homogenous magnetic field has to be generated.

FIG. 2 shows these mercury spectral lines generated by the light source 12 together with the absorption spectrum 13 of the natural mercury, such as occurs in a gas to be measured. The magnetic field is so strong at the point of the gas discharge that the σ+ component λ1 is pushed out of the absorption, while the σ− component λ2 still lies in the absorption. The magnetic field for this typically amounts to approximately 0.7 Tesla.

As will be explained further below, the sufficient separation is important because λ2 ultimately delivers the measured parameter, since the σ− component is absorbed and the σ+ component λ1 forms a reference value since it is not absorbed by the mercury in the absorption cell.

The light then passes through a photoelastic modulator 24 in which the oppositely circularly polarized o components are influenced differently due to the birefringent properties of the modulator 24. This different influencing takes place in the rhythm of an applied AC voltage which is provided by a voltage supply 28. Only the σ+ component is thereby transmitted at specific times and only the a- component at specific other times. A time division of σ+ and σ− components thus takes place with the aid of the photoelastic modulator 24.

The light then passes through a measuring cell 30 with the mercury contamination contained therein and to be measured. The measuring cell 30 has inflows and outflows 30-1 and 30-2 for the gas to be examined as well as a heating 32 to heat the gas so that the mercury is present in the atomic state where possible. The a component still located within the absorption spectrum undergoes an absorption at the mercury atoms in the measuring cell 30, whereas the σ+ component does not undergo any absorption due to the energy displacement from the absorption so that the light of this line can serve as a reference line. The light is reflected at a retroreflector 35 and passes through the measuring cell a second time.

Finally, the light is decoupled by means of a beam splitter 37 and is received on the light receiver 34 and supplied to a lock-in amplifier 38 which is triggered by the AC voltage supplied to the photoelastic modulator 24. The result is that then a signal is received by the lock-in amplifier such as is shown qualitatively in FIG. 1 with the reference numeral 40. The light receiver 34 therefore alternately receives reference light and the non-absorbed portion of the measured light with the frequency of the modulation control voltage so that the difference from this, that is the amplitude of the curve 40, is a measure for the absorption in the measuring cell 30, and thus a measure for the mercury concentration, so that the concentration of the mercury in the gas to be examined can be determined from this signal.

The test cuvettes 31 shown schematically in FIG. 3 serve for the calibration of the gas analyzer 10. Basically, a single test cuvette 31 is sufficient for the calibration.

The test cuvette 31 comprises a quartz glass and is closed in a gas tight manner and filled with benzol of a concentration of approximately 1% and 1000 mbar at room temperature. Windows 31-1 and 31-2 are provided for the light inlet and light outlet. The optical path length L preferably amounts to between 10 and 20 mm, with a set of test cuvettes 31 being shown in FIG. 3 each having different optical path lengths L. The diameter of the test cuvettes 31 typically amounts to 20 mm.

Such a test cuvette 31 can be introduced into the beam path for the calibration of the gas analyzer 10, with the test cuvette 31 having a mirror 31-3 in the embodiment in accordance with FIG. 1 so that the light does not pass through the measuring cell 30 and can be decoupled onto the receiver 34. Generally, the test cuvette could also be used instead of the measuring cuvette 30 or in addition to the measuring cuvette, with it then being used with zero gas, e.g. being flushed with nitrogen. The test cuvette 31 then needs the windows shown in FIG. 3.

FIG. 4 shows the absorption spectrum of benzol in the relevant wavelength range. Benzol has a low absorption band A between 230 and 270 nm. The layers λ1 and λ2 of the Zeeman components of the absorption line of ¹⁹⁸Hg are additionally drawn in. The difference d of the intensities of the calibration measurement signal at these two layers is proportional to the concentration present in the test cuvette at a constant temperature and pressure of benzol so that the gas analyzer can be calibrated with the measurements of the test cuvette. The temperature of the test cuvette as a rule lies between room temperature and 50° C.

The absorption spectrum of the benzol does not have to be known qualitatively (absolute absorption level as a function of the wavelength. What is important is that it is present and constant in time. A “calibration” of the gas analyzer can then take place in accordance with the following principle, for example. First, the gas analyzer itself is calibrated at the start, that is e.g. on the putting into operation, by means of charging a known mercury concentration into the measuring cuvette. Subsequently, the test cuvette is pivoted in and its measured value is kept as the calibration value from this time. In all following calibrations or checks, the test cuvette is pivoted in and the obtained measured value is compared with the calibration value and optionally adapted to the sensitivity of the gas analyzer.

Different test cuvettes 31 having different lengths are introduced into the beam path for a linearity check of the gas analyzer 10 and a check is made whether the measured signals correspond to the optical path lengths. So that the same concentration of benzol is always present in the test cuvettes in this check and allows a comparison of the measurements at different wavelengths, the test cuvettes 31 are preferably mutually connected.

1. A mercury gas analyzer for measuring the mercury content of a gas having an Hg light source which transmits transmitted light having wavelengths of at least one spectral line of the mercury, a measuring cell including gas containing mercury, a light receiver, an evaluation unit and a test cuvette which can be introduced into the beam path for checking the operability, wherein the test cuvette contains benzol as a test gas.

2. A gas analyzer in accordance with claim 1, wherein the concentration of the benzol amounts to 1%.

3. A gas analyzer in accordance with claim 1, wherein the optical light path length in the test cuvette amounts to approximately 2 cm.

4. A gas analyzer in accordance with claim 1, wherein the pressure in the test cuvette amounts to approximately 1000 mbar.

5. A gas analyzer in accordance with claim 1, wherein the temperature in the test cuvette lies approximately between room temperature and 50° C.

6. A gas analyzer in accordance with claim 1, wherein a plurality of mutually connected test cuvettes each having different optical path lengths is provided.

7. A method of calibrating a mercury gas analyzer, comprising the steps:
generating light having wavelengths of at least one Hg spectral line by an Hg light source;
providing a test cuvette with benzol of a known concentration as a test gas and thus with known calibration values of the test cuvette at the wavelengths of the Hg spectral line;
inserting the test cuvette into the beam path; and
calibrating the gas analyzer to the known calibration values.

8. A method in accordance with claim 7, wherein, on the putting into operation of the gas analyzer, the gas analyzer is first calibrated for the first time by means of charging a known mercury concentration into the measuring cuvette and then a measured value for the test cuvette is determined and is saved as a calibration value and the currently obtained measured value is compared with the calibration value in all following calibrations with the test cuvette and the gas analyzer is thus calibrated in operation.

9. A method in accordance with claim 7, wherein different test cuvettes having different optical wavelengths are used.
